(19) United States
(12) Patent Application Publication
(10) Pub. No.: US 2009/0092700 A1
(43) Pub. Date: Apr. 9, 2009

(54) INJECTION MOLDING MACHINE

(75) Inventors: Tatsuya Yokoyama, Chiba (JP); Masaru Takahashi, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd.

(21) Appl. No.: 11/989,602

(22) PCT Filed: Aug. 10, 2006
(86) PCT No.: PCT/JP2006/315854

§ 371 Date: Jan. 29, 2008

(30) Foreign Application Priority Data
Aug. 12, 2005 (JP) 2005-234854

(51) Int. Cl. B29C 45/03

(52) U.S. Cl. 425/135

(57) ABSTRACT

A second display device is provided separately from a first display device that displays information regarding molding conditions. The second display device displays character information or picture information. A control part includes a first data conversion part that data-converts the information to be displayed on the first display device and a second data conversion part that data-converts the information to be displayed on the second display device. The second display device displays information different from the first display device.

### TECHNICAL FIELD

The present invention relates to injection molding machines and, more specifically, to an injection molding machine having a display device for displaying information such as a molding condition.

### BACKGROUND ART

In recent years, a display device is provided to many injection molding machines for molding a molded product such as a plastic part or the like so as to display various kinds of information regarding injection molding. The information displayed on a display device of an injection molding machine includes information regarding items input by an operator and information regarding various kinds of molding conditions obtained during molding.

The display device is provided to display information to the operator of the injection molding machine, and, normally, it is integrated with a key operation input part. Or, one having a display screen itself functioning as an input device for inputting information by an operator such as a touch panel is also used. Accordingly, in many cases, the display device is positioned on a side face near a middle part where a mold-clamping device of the injection molding machine is located. Additionally, in many cases, the display device is located at a position of a height of eyes of an operation so that it can be easily viewed by the operator. In this way, the conventional display device is arranged at a position where an operator can see the display device while observing an operation of the injection molding machine.

In many cases, a plurality of injection molding machines are installed in a molding shop where injection molding machines are operated. When a plurality of injection molding machines are operated, one operator may manage the plurality of injection molding machines. In this case, in order to grasp molding conditions and operating conditions of the plurality of injection molding machines, the operator is required to move to a position near the display device of each of the injection molding machines to see the display device.

An injection molding machine having the above-mentioned display device is disclosed in, for example, Patent Document 1.

Patent Document 1: Japanese Laid-Open Patent Application No. 2003-200456

### DISCLOSURE OF THE INVENTION

### Problems to be Solved by the Invention

If a plurality of injection machines each having a display device are installed and when an operator is near a display device of one of the injection molding machines, the operator cannot see display devices of other injection molding machines. Additionally, because the display device is normally configured and arranged to be seen mainly at a position close to the display device, it is difficult to check contents of display on the display device from a remote position. For example, in a molding shop where a plurality of injection molding machines are installed, it is difficult to grasp a condition of each of the plurality of injection molding machines through the display devices virtually simultaneously from a certain position (a control room or the like) in the molding shop.

There is a case where an injection molding machine is provided with an alarm device that announces, when an abnormal situation such as a malfunction occurs, the abnormal situation by lighting a red lamp. However, such an alarm device merely announces an occurrence of the contents of the abnormal situation, and it cannot notify an operator of contents of the abnormal condition. That is, the operator can check the contents of the abnormal situation of the injection molding machine through the display device firstly when moved closed to the display device of the injection molding machine.

As mentioned above, there is a problem in the display device of the conventional injection molding machine that it is difficult to check the contents of the display from a remote position. Additionally, there also is a problem in the alarm device of the conventional injection molding machine that it can merely generate an alarm and cannot notify an operator of the contents of an abnormal situation.

### Means to Solve the Problems

It is a general object of the present invention to provide a novel and useful injection molding machine in which the above-mentioned problems are eliminated.

A more specific object o the present invention is to provide an injection molding machine of which operating condition can be checked from a remote place.

In order to achieve the above-mentioned objects, there is provided according to the present invention an injection molding machine comprising: a first display device that displays information regarding molding conditions; and a second display device that is provided separately from the first display device and displays character information or picture information.

It is preferable that the above-mentioned injection molding machine further comprises a control part that controls the first display device and the second display device, wherein the control part includes a first data conversion part that data-converts the information to be displayed on the first display device and a second data conversion part that data-converts the information to be displayed on the second display device. Additionally, the second display device may be arranged at a position remote from a main body of the injection molding machine. The second display device is preferably configured to display information different from that displayed on the first display device. Additionally, the second display device may be configured to display by a character size larger than a character size used for display on a setting screen of the first display device. It is preferable that the second display device is configured to display in a direction different from a direction of display of the first display device. The second display device is preferably arranged at a position higher than the first display device. The second display device may be configured to display information regarding production conditions. The second display device may be configured to display information regarding operation schedule in response to a predetermined time.

### EFFECTS OF THE INVENTION

According to the present invention, the second display device can be arranged so that it can be seen from a place remote from the injection molding machine, and an operator at a remote place can be notified of information regarding the injection molding machine. Because the second display device displays character information, the operator at the remote place can be notified of information of various kinds of contents.

### BRIEF DESCRIPTION OF THE DRAWINGS

FIG. 1 is a side view of an injection molding machine according to a first embodiment of the present invention.

FIG. 2 is a plan view showing a plurality of injection molding machines installed along a passage of a molding shop.

FIG. 3 is an illustration showing contents of display of a display device.

FIG. 4 is a side view of an injection molding machine according to a second embodiment of the present invention.

### EXPLANATION OF REFERENCE NUMERALS

10 mold-clamping apparatus
12 injection apparatus
14 frame
16 cover
16A fixed cover
16B slide cover
20 first display device
22 control part
24 memory part
26 first data conversion part
28 second data conversion part
30 second display device
40 radio transmitter
42 radio receiver

### BEST MODE FOR CARRYING OUT THE INVENTION

A description will be given, with reference to the drawings, of embodiments of the present invention.

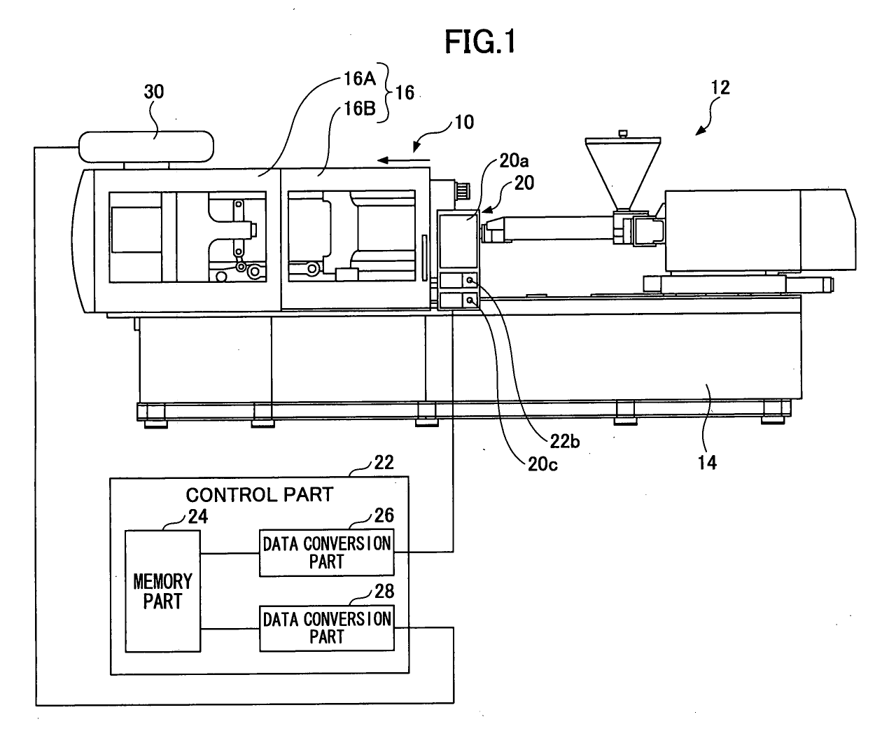

FIG. 1 is a side view of an injection molding machine according to a first embodiment of the present invention. The injection molding machine shown in FIG. 1 has a structure in which a mold-clamping apparatus 10 and an injection apparatus 12 are mounted on a frame 14. Since the mold-clamping apparatus 10 has many movable parts, a cover 16 is provided on a side face. The cover 16 includes a fixed cover 16A and a slide cover 16B. When an operator operates the injection molding machine, the operator can touch the mold-clamping apparatus 10 directly by causing the slide cover 16B slid in a direction of an arrow. If it is not necessary to touch the mold-clamping apparatus 10, a molding operation is performed in a state where the slide cover 16B is closed.

The injection molding machine according to the present embodiment is provided with a display device 20 for displaying information regarding input information and molding conditions. The display device as a first display device is arranged at a position between the mold-clamping apparatus 10 and the injection apparatus 12 (almost in a middle of axial direction of the injection apparatus) where operator can see easily so that operator can operate easily. That is, when the operator is at a side of the mold-clamping-apparatus 10, or at a side of the injection apparatus 12, the display device 20 is arranged to be near the operator.

The display device 20 has a display screen 20a that displays information, an operation part 20b including switches or the like for operating the injection molding machine, and an input setting part 20c for inputting data for setting molding conditions. It should be noted that although the display device 20 has a structure the same as a display/input device provided in a conventional injection molding machine, a different display device other than the display device 20 in the present embodiment as mentioned later. In the present specification, the display device may be referred to as a first display device and another display device may be referred to as a second display device so as to distinguish the display device 20 and the another display device mentioned later from each other.

When operating the injection molding machine, the operator of the injection molding machine inputs data for setting molding conditions through the operation part 20b of the display device 20. The input data is sent to a control part 22 that controls operations of the injection molding machine. The control part 22 processes the input data and stores it in a memory part 24. Additionally, the control part 22 sends the processed input data to the display device through a data conversion part 26. The data conversion part 26 converts the data to be sent to the display device 20 into character data or image data so as to be displayed on the display screen 20a.

When operating the injection molding machine after setting molding conditions, the operator operates the switches of the operation part 20b of the display device 20 so as to drive each part of the injection molding machine. The data indicating operating conditions of the injection molding machine in molding operation is stored in the memory part 24 of the control part 22 and is also sent to the display device 20 via the first data conversion part 26 similar to the input data and displayed on the display screen 20a. Accordingly, the operator can check the operating condition of the injection molding machine by the contents displayed on the display screen 20a of the display device 20.

It should be noted that, in the present embodiment, the above-mentioned control part 22 is an electronic control circuit constituted by using a CPU, a ROM, a RAM, etc., and serves as a part of the control device provided in the injection molding machine.

In the injection molding machine of the above-mentioned structure, in the present embodiment, a display device 30, which serves as a second display device, is attached to an upper surface of the fixed cover 16. The display device 30 is a display device provided to exclusively display data sent from the control device 22 as mainly character information (including picture information). The data sent to the second display device 30 is changed into data format which can be displayed by the second display device 30 by a second data conversion part 28.

Although the display device 30 may have an input part and an operation part similar to the display device 20, it is preferable that the display device 30 is a device merely having a display screen since display is a main function. As the display device 30, a display device that can display characters and pictures, such as a display constituted by a number of light-emitting diodes (LEDs) or a liquid display device (LCD), is preferably used. Especially, since the display 30 is provided for the purpose of notifying a remote operator of information, it is preferable that the display device 30 can display large characters with high brightness.

The display device 30 is attached to an upper part of the fixed cover 16A and arranged at a high position. Accordingly, if a plurality of molding machines are arranged in a mold shop, the display contents of the display device 30 can be visually recognized without interference by obstacles.

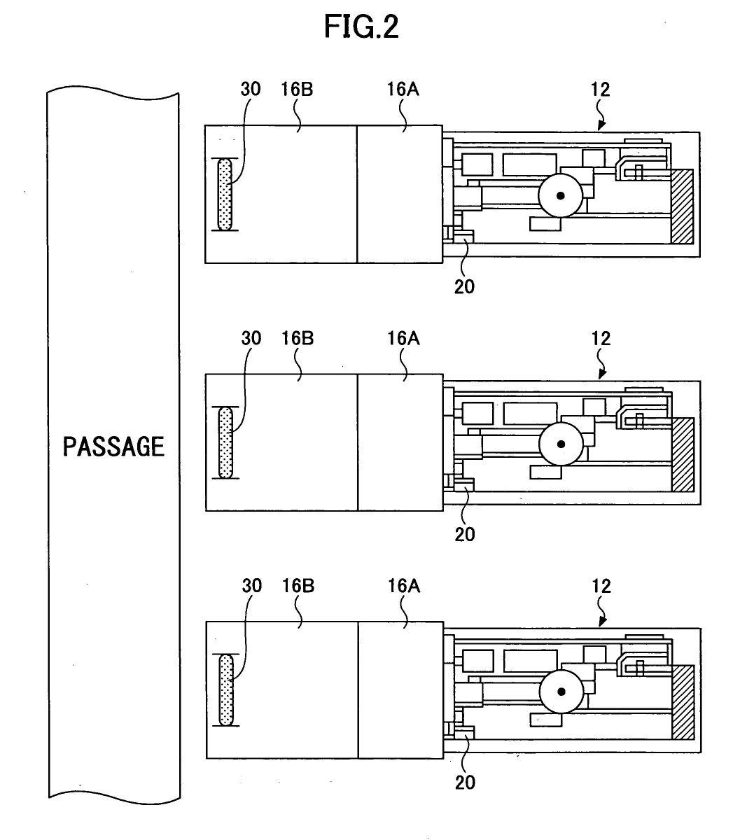

FIG. 2 is a plan view showing a plurality of injection molding machines installed along a passage of a molding shop. When installing a plurality of injection molding machines in a molding shop, there are many cases in which the injection molding machines are arranged in alignment so that a longitudinal direction of each of the injection molding machines is perpendicular to a passage. In such a case, the first display device 20 of each of the injection molding machines is located at a position where it is difficult to see the first display device 20. Thus, as shown in FIG. 2, it is preferable to locate the second display device 30 at an end portion in the longitudinal direction and arrange a display face to face the passage. Thereby, an operator can grasp an operating state of each of the injection molding machines by moving along the passage while seeing the contents of display of the display device 30.

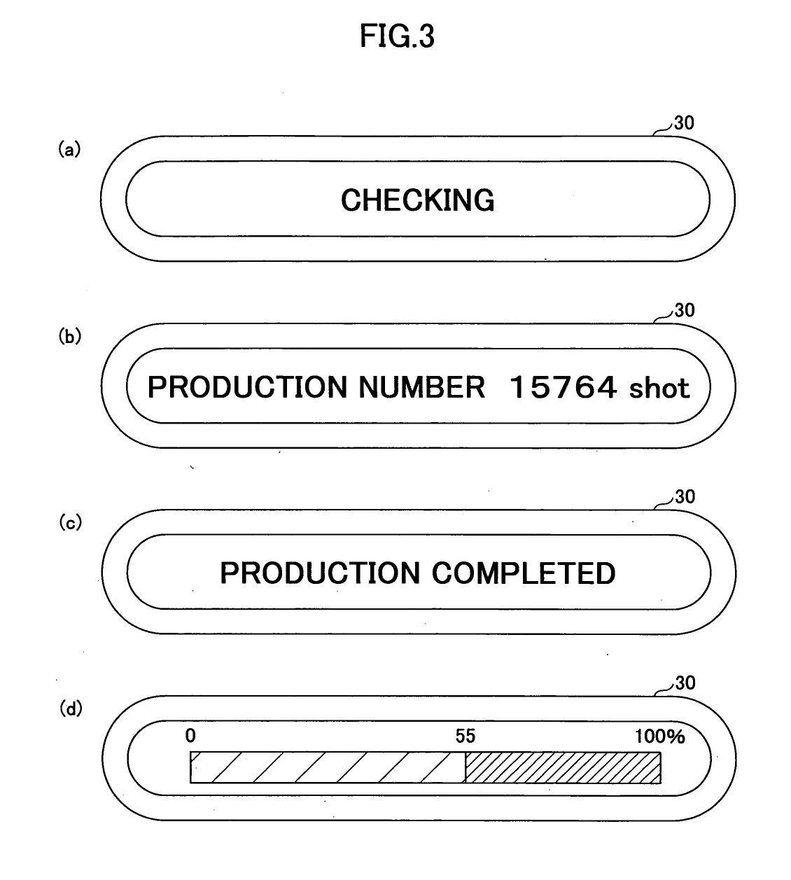

Next, a description will be given, with reference to FIG. 3, of contents of information displayed on the second display device 30. Although the information displayed on the display device 30 is information regarding operation situation or operation schedule of an injection molding machine, any kind of information or data may be displayed as long as the information or data is processed by the control part 22 of the injection molding machine. However, because an amount of information which the display device 30 can display at one time is not so large, it is preferable to display information which can be represented by a simple term or sentence or a simple picture or graph.

As an example of the specification of a display part of the second display device 30, there are the following items. However, the specification of the display 30 is not limited to the specification shown below, and a display device of various specifications may be used according to an injection molding machine or an environment of a place where the injection molding machine is installed or contents of information to be displayed.

| | |
|---|---|
| screen size: | 316.5 × 35.7 mm |
| dot number: | 264 × 4 dots |
| dot size: | 0.9 × 1.2 mm |
| dot pitch: | 1.2 × 1.5 mm |
| luminescence color: | green (λ p = 505 nm) |
| brightness: | 700Typ. cd/m² |

Additionally, the number of dots of the display screen may be increased. In such a case, by increasing the number of dots, a larger amount of information can be expressed or a character size or the like can be increased.

Furthermore, the dot size may be decreased, in such a case, information can be displayed more finely so that an operator can easily recognize the contents of display.

FIG. 3 is an illustration showing contents of display of the second display device 30.

For example, in an example shown in FIG. 3-(a), the fact that the injection molding machine is in “checking” is indicated on the display device 30 by character information. An operator can recognize that the injection molding machine concerned is being checked and is not in operation merely by seeing the display from a remote place.

In an example shown in FIG. 3-(b), information that “production number is 15764 shot” is indicated on the display device 30 by character information. An operator can recognize that the injection molding machine concerned is in operation and is presently performing molding of 15764 shot merely by seeing the display from a remote place. In this case, the number of shots displayed is increased when each shot is completed.

In an example shown in FIG. 3-(c), information that “production is completed” is indicated on the display device 30 by character information. An operator can recognize that an operation of the injection molding machine concerned has been ended and the production has been completed merely by seeing the display from a remote place.

In an example shown in FIG. 3-(d), production progress is indicated on the display device 30 by picture information such as a bar graph. An operator can recognize the operation schedule of the injection molding machine concerned merely by seeing the display from a remote place. That is, the operator can recognize instantaneously that from a remote place that 55% of the scheduled production number has already been ended and the production schedule of the rest is 45%. It is preferable that the indication of operation schedule is displayed, for example, at one-hour interval or at noon and at 5 o'clock in the afternoon.

The above examples are a part of contents of information displayed on the display device 30, and various kinds of character information and picture information can be displayed so as to send notification to an operator at a remote place.

The display device 30 is provided to visually notify a remote operator of information, and, thus, it is preferable that characters and pictures to be displayed are in a size which can be recognized from a remote place. For example, it is preferable that it is larger than characters and pictures normally displayed on a setting screen of the first display device 20 and, if it is a character, it is preferably a size greater than 50 font.

Additionally, if character information cannot be displayed on the display device 30 at one time, characters may be moved continuously in a transverse direction so as to display a long sentence. Or, one sentence may be divided into a plurality of times.

Additionally, information to notify may be added by distinguishing characters and pictures by color. For example, if it is display of red characters, it may notify of the fact that urgent response is needed due to a failure or the like. In such a case, red may indicate urgency and the contents may be displayed by the characters. By changing the color, a level of urgency may be notified. Additionally, a level of urgency may be notified by turning the display on and off.

Additionally, the content of display on the display device 30 may not be limited to one, and different items of information may be displayed for each three seconds, for example.

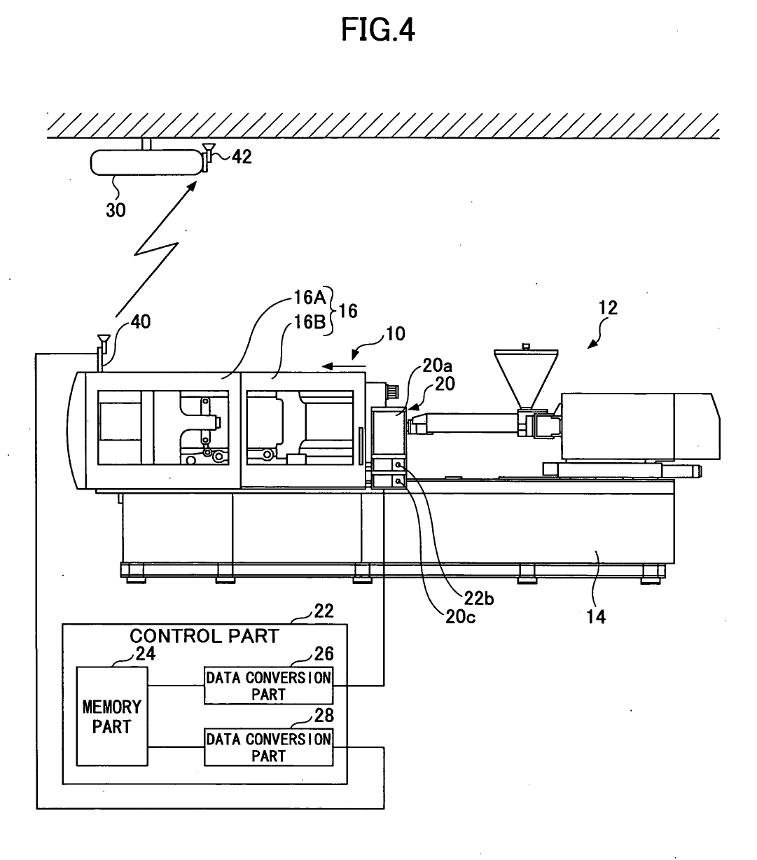

Next, a description will be given, with reference to FIG. 4, of a second embodiment of the present invention. FIG. 4 is a side view of an injection molding machine according to the second embodiment of the present invention. In FIG. 4, parts that are the same as the parts shown in FIG. 1 are given the same reference numerals, and descriptions thereof will be omitted.

The injection molding machine according to the second embodiment of the present invention is configured to perform data transmission to the display device 30 by radio communication in the injection molding machine according to the above-mentioned first embodiment. In order to transmit data by radio frequency, a radio transmitter 40 is attached to the injection molding machine and a radio receiver 42 is attached to the second display device 30.

Display data which is data-converted by the second data conversion part 28 of the control part 22 is sent to the radio transmitter 40. The radio transmitter 40 converts the sent display data into radio signals and radio-transmits the signals. The second display device 30 installed within a transmission area receives the radio signals by the radio receiver 42, and the display device 30 converts the radio signals into display data and display the display data.

In the example shown in FIG. 4, the second display 30 is attached to the ceiling of the molding shop, and the display of the display device 30 can be seen even from a remote place. However, the mounting location of the display device 30 is not limited to a ceiling, and may be installed at an arbitrary place if it is within a transmission area of the radio transmitter.

As mentioned above, in the present embodiment, the second display device 30 is arranged at a position remote from the main body of the injection molding machine on which the first display device 20 is provided, and the second display device 30 can be visually recognized even from a remote place. Additionally, by transmitting data by radio frequency to the second display device 30, a degree of freedom in mounting place of the display device 30 is increased, and the second display device 30 can be installed at a place where maximum visibility is given in the periphery of the injection molding machine.

It should be noted that contents to be displayed on the display device 30 are the same as the display contents in the above-mentioned first embodiment.

The present invention is not limited to the specifically disclosed embodiments and variations and modifications may be made without departing from the scope of the present invention.

The present application is based on Japanese priority application No. 2005-234854 filed Aug. 12, 2005, the entire contents of which are hereby incorporated herein by reference.

### INDUSTRIAL APPLICABILITY

The present invention is applicable to an injection molding machine having a display device that displays information such as molding conditions.

1. An injection molding machine comprising:
a first display device that displays information regarding molding conditions; and
a second display device that is provided separately from the first display device and displays character information or picture information.

2. The injection molding machine as claimed in claim 1, further comprising a control part that controls said first display device and said second display device, wherein the control part includes a first data conversion part that data-converts the information to be displayed on said first display device and a second data conversion part that data-converts the information to be displayed on said second display device.

3. The injection molding machine as claimed in claim 1, wherein said second display device is arranged at a position remote from a main body of said injection molding machine.

4. The injection molding machine as claimed in claim 1, wherein said second display device is configured to display information different from that displayed on said first display device.

5. The injection molding machine as claimed in claim 1, wherein said second display device is configured to display by a character size larger than a character size used for display on a setting screen of said first display device.

6. The injection molding machine as claimed in claim 1, wherein said second display device is configured to display in a direction different from a direction of display of said first display device.

7. The injection molding machine as claimed in claim 1, wherein said second display device is arranged at a position higher than said first display device.

8. The injection molding machine as claimed in claim 1, wherein said second display device is configured to display information regarding production conditions.

9. The injection molding machine as claimed in claim 1, wherein said second display device is configured to display information regarding operation schedule in response to a predetermined time.
